(19) United States
(12) Patent Application Publication
(10) Pub. No.: US 2026/0189720 A1
(43) Pub. Date: Jul. 2, 2026

(54) IMAGE PROCESSING METHOD AND SYSTEM

(71) Applicant: FPT USA CORP., Richardson, TX (US)

(72) Inventors: Tin Trung DUONG, Quy Nhon City (VN); Long TRAN-THANH, Quy Nhon City (VN); Nhat Cuong NGUYEN, Quy Nhon City (VN); Hoang Ha Huy NGUYEN, Quy Nhon City (VN); Tung Xuan DAO, Quy Nhon City (VN); Trung Quoc DUONG, Quy Nhon City (VN)

(73) Assignee: FPT USA CORP., Richardson, TX (US)

(21) Appl. No.: 19/003,240

(22) Filed: Dec. 27, 2024

(51) Int. Cl. H04N 19/42; G06V 10/44; H04N 19/20

(52) U.S. Cl. CPC H04N 19/42; G06V 10/443; H04N 19/20

(57) ABSTRACT

The present disclosure relates to an image processing method. The method may include: receiving an input image to be compressed; extracting features of the input image; encoding the extracted features of the input image into a latent feature, zᵢₙₚᵤₜ, determining, from a background image database which contains one or more background images, a background image that has a latent feature, z_{background}, best-matching with zᵢₙₚᵤₜ; calculating a delta feature, Δz, which is the difference between zᵢₙₚᵤₜ and z_{background}, in accordance with the following formula: Δz=zᵢₙₚᵤₜ−z_{background}; and compressing Δz to obtain a bitstream, Y_{differences}. The method may further include: sending Y_{differences} and an identifier (IDentifier—ID) of z_{background} to a server; retrieving z_{background} based on the ID of z_{background}; decompressing Y_{differences} based on z_{background} to retrieve Δz; calculating a reconstructed latent feature, z_{reconstructed}, in accordance with the following formula: z_{reconstructed}=Δz+z_{background}; and decoding z_{reconstructed} to obtain a reconstructed input image. An image processing system and a computer program are further disclosed.

### CROSS-REFERENCE TO RELATED APPLICATIONS

Not Applicable.

### TECHNICAL FIELD

The present disclosure relates to an image processing method and system, and a computer program, more particularly, for compressing and decompressing an image based on its latent features instead of compressing and decompressing the image itself, using Artificial Intelligence (AI) model.

### BACKGROUND OF THE INVENTION

Artificial Intelligence (AI) is a scientific field that is related to building computers as well as machines that can learn, reason and act in such a way that would normally require the intelligence of humans, or that includes data of which the scale goes beyond what humans can analyze. AI is an ability of a machine to replicate or enhance human intelligence, such as learning and reasoning from experiences. AI has been used in computer programs for many years, and is now applied to a variety of other products and services. For example, AI software can be used for compressing and decompressing an image.

Currently, there are technologies for compressing and decompressing an image, for example, Lossy Image Compression with Conditional Diffusion Models (CDC), however, this known technology has a drawback in that it relies on the original image features which requires a lot of storage space.

Another known technology is H.264/H.265. This technology, however, has a drawback which is a trade-off between the image quality and the compression ratio or the image size. This trade-off can be critical in surveillance systems, where an image clarity maintenance is essential for accurate monitoring and identification tasks.

Another known technology is an AI-based compression technology. Recent advancements in AI-based video compression techniques have shown promising results in reducing data sizes while preserving image quality. However, most of these techniques are designed for offline processing of images or videos, which limits their applicability in real-time surveillance systems. In addition, current AI-based image/video compression algorithms are only focused on general video and camera (both moving and fixed), but there has not been a specific optimal algorithm for fixed camera environment, so the AI model will take a lot of computing resources in order to compress the image well and maintain the image quality.

Some known technologies are specialized for compressing videos which are available on a computer, so they are not suitable to be used for capturing, compressing and transmitting data simultaneously as in a remote surveillance camera system. For example, a known algorithm is aimed at compressing any video, it is necessary to check whether the original image is still suitable for compression and decompression, by comparing the compressed and decompressed image with the original image of the video. While in the actual surveillance camera system, this comparison is not feasible, as the system performs the compression and transmits the compressed image to the server, i.e., the original image and the compressed image are on two different devices.

Another known technology is End-To-End Compression for Surveillance Video with Unsupervised Foreground-Background Separation. This technology requires continuous background image checking and is therefore time-consuming for computation. Further, though this technology achieves good compression ratios, it has limitations in real-time performance on edge devices. Due to the complicated Mask Net and the computing burden of motion estimation and compensation, this technology is not suitable for real-time operation on devices having limited processing capability, such as embedded cameras. The main difficulty of this technology is that it is not feasible to perform real-time compression on edge devices, because the computing requirements for separating and processing the background and foreground exceed the capabilities of conventional hardware in these environments. This makes this technology unfeasible for many real-time applications.

Therefore, there is a need for an image compression and decompression technology which can compress and decompress an image well and, at the same time, maintain the image quality in real time. This technology can address some or all of the above-mentioned limitations.

### SUMMARY OF THE INVENTION

To address some or all of the above-mentioned limitations, the present disclosure proposes an image processing method, system, and a computer program. This solution may leverage AI-based image compression and decompression models to optimize the transmission of images from CCTV (Closed-Circuit Tele Vision) cameras in real time. This solution aims to enhance transmission efficiency while preserving image quality, ensuring that remote monitoring systems can operate effectively without significant data loss or latency.

It should be noted that aspects and objects of the present disclosure should not be limited to the above-described aspects and objects, and other aspects and objects of the present disclosure will be apparent to those skilled in the art from the present disclosure.

In a first aspect, the present disclosure provides an image processing method, which can be used for compressing an image, such as the image captured by an edge device in a CCTV camera system, the method may include:
receiving, by an edge device, an input image to be compressed;
extracting, by the edge device, features of the input image;
encoding, by the edge device, the extracted features of the input image into a latent feature zᵢₙₚᵤₜ;
determining, by the edge device, from a background image database which contains one or more background images, a background image that has a latent feature z_{background} best-matching with the latent feature zᵢₙₚᵤₜ;
calculating, by the edge device, a delta feature Δz, which is the difference between zᵢₙₚᵤₜ and z_{background}, in accordance with the following formula: Δz=zᵢₙₚᵤₜ−z_{background}; and
compressing, by the edge device, Δz to obtain a bitstream Y_{differences}.

In a possible implementation of the first aspect, a threshold threshold_T may be used when calculating Δz, where Δz is set to zero if its absolute value is less than the threshold threshold_T.

In a possible implementation of the first aspect, the threshold threshold_T may range from 0.5 to 3.0.

In a possible implementation of the first aspect, the threshold threshold_T may be 1.5.

In a possible implementation of the first aspect, before the receiving of the input image to be compressed, the method may further comprise:
constructing the background image database;
extracting features of each of the background images in the database;
encoding the extracted features of each of the background images into a latent feature z_{background}; and
assigning an identifier (IDentifier—ID) to each z_{background}.

In a possible implementation of the first aspect, the extracting of features of the input image and the encoding of the extracted features of the input image into a latent feature zᵢₙₚᵤₜ may be implemented by using a modified CDC (Conditional Diffusion Compression) model.

In a possible implementation of the first aspect, the extracting of features of each of the background images in the database and the encoding of the extracted features of each of the background images into a latent feature z_{background} may be implemented by using a modified CDC (Conditional Diffusion Compression) model.

In a second aspect, the present disclosure provides an image processing method, which can be used for processing a compressed image, such as the compressed image obtained by the method in the first aspect, to obtain a reconstructed input image, and may include:
sending, by the edge device, the compressed bitstream Y_{differences} and an identifier (IDentifier—ID) of the latent feature z_{background} to a server;
retrieving, by the server, z_{background} based on the ID of z_{background};
decompressing, by the server, Y_{differences} based on z_{background} to retrieve the delta feature Δz;
calculating, by the server, a reconstructed latent feature z_{reconstructed} in accordance with the following formula: z_{reconstructed}=Δz+z_{background}; and
decoding, by the server, the reconstructed latent feature z_{reconstructed} to obtain a reconstructed input image.

In a third aspect, the present disclosure provides an image processing system, which can be used for compressing an image, such as that captured by an edge device in a CCTV camera system, and may include:
an edge device configured to perform the following steps:
receiving an input image to be compressed;
extracting features of the input image;
encoding the extracted features of the input image into a latent feature zᵢₙₚᵤₜ;
determining, from a background image database which contains one or more background images, a background image that has a latent feature z_{background} best-matching with the latent feature zᵢₙₚᵤₜ;
calculating a delta feature Δz, which is the difference between the zᵢₙₚᵤₜ and z_{background}, in accordance with the following formula: Δz=zᵢₙₚᵤₜ−z_{background}; and
compressing Δz to obtain a bitstream Y_{differences}.

In a fourth aspect, the present disclosure provides an image processing system, which can be used for decompressing a compressed image, such as the compressed image obtained by the system in the third aspect, to obtain a reconstructed input image. This system may include the edge device in the system in the third aspect, which edge device may further be configured to perform a step for sending the compressed bitstream Y_{differences} and an identifier (IDentifier—ID) of the latent feature z_{background} to a server. And this system may further include a server configured to perform the following steps:
retrieving z_{background} based on the ID of z_{background};
decompressing Y_{differences} based on z_{background} to retrieve the delta feature Δz;
calculating a reconstructed latent feature z_{reconstructed} in accordance with the following formula: z_{reconstructed}=Δz+z_{background}; and
decoding the reconstructed latent feature z_{reconstructed} to obtain a reconstructed input image.

As the concepts and principles of the systems in the third and fourth aspects are the same as those of the methods in the first and second aspects, repeated descriptions thereof are omitted for the sake of brevity.

In a fifth aspect, the present disclosure provides a computer program which, when run on a computer having one or more processors, causes the one or more processors to perform the method in the first aspect and/or the method in the second aspect.

In a sixth aspect, the present disclosure provides a computer-readable storage medium, the computer-readable storage medium stores a computer program which, upon being executed by a computer having one or more processors, causes the one or more processors to perform the method in the first aspect and/or the method in the second aspect.

The effects of the present disclosure should not be limited to the above-mentioned effects, and other effects that are not mentioned in the present disclosure will be apparently understood by those skilled in the art from the description and the appended claims.

### BRIEF DESCRIPTION OF DRAWINGS

The accompanying drawings are included to provide a further understanding of the present disclosure, incorporated in, and constitute a part of the specification. The accompanying drawings illustrate embodiments of the present disclosure and, together with the description, explain the principles of the present disclosure.

In the drawings:

FIG. 1 is a schematic diagram illustrating an image processing method according to a first embodiment of the present disclosure;

FIG. 2 is a schematic diagram illustrating an image processing method according to a second embodiment of the present disclosure, which may be continuous from the method in the first embodiment;

FIG. 3 is a schematic diagram illustrating an image processing system according to a third embodiment of the present disclosure; and

FIG. 4 is a block diagram illustrating an exemplary computer architecture for implementing aspects of the present disclosure, according to some embodiments of the present disclosure.

### DETAILED DESCRIPTION OF EMBODIMENTS

Advantages and characteristics of the present disclosure and a method of achieving the same will be made to be clear by referring to exemplary embodiments described in detail below together with the accompanying drawings. However, the present disclosure is not limited to the exemplary embodiments disclosed herein but may be implemented in various forms. The exemplary embodiments are provided by way of example only so that a person skilled in the art can fully understand the present disclosure.

The features of various embodiments of the present disclosure can be partially or entirely combined with each other and can be operated in various ways, and the embodiments can be carried out independently of or in association with one another.

The order of steps or order for performing certain actions is immaterial as long as the present disclosure remains operable. That is, a certain step may occur in an order different from that described herein, or concurrently with another step.

When the terms such as “after,” “subsequent to,” “next to,” “before,” and the like, are used for describing a temporal relationship, cases where any two events are not consecutive or not sequential may be included, unless the term “immediately” or “directly” is explicitly used. That is, one or more other events may occur between those two events, unless a more limiting term such as “just,” “immediate(ly),” or “direct(ly)” is used.

The terms such as “comprising,” “including,” “having,” and “consist of” used herein are generally intended to allow other components to be added unless the terms are used with the term “only.”

Unless otherwise defined, terms used herein (including technical and scientific terms) have common meanings that would normally be interpreted by a person skilled in the art. Further, terms such as those defined in commonly used dictionaries should be interpreted as having a meaning consistent with their meaning in relevant art and should not be interpreted in an idealized or overly formal sense, unless expressly defined otherwise.

Although the terms “first,” “second,” and the like are used for describing various components, these components are not confined by these terms. These terms are merely used for distinguishing one component from the other components. Therefore, a first component to be mentioned below may be a second component in a technical concept of the present disclosure.

Any references to singular may include plural unless expressly stated otherwise. And “a plurality of” means two or more. Further, the phrase “at least one” should be understood as including any and all combinations of one or more of listed items. For example, each of the phrases “at least one of a first item, a second item, or a third item” and “at least one of a first item, a second item, and a third item” may represent a combination of two or more of the first item, the second item, and the third item, or may represent only one of the first item, the second item, or the third item.

Like reference numerals generally denote like elements throughout the specification.

In the following description of the present disclosure, “/” means “or” unless otherwise specified. For example, A/B may represent A or B. In this specification, “and/or” describes only an association relationship for describing associated objects and represents that three relationships may exist. For example, A and/or B may represent the following three cases: Only A exists, both A and B exist, and only B exists.

In the following description of the present disclosure, a detailed explanation of known related technologies may be omitted to avoid unnecessarily obscuring the subject-matters of the present disclosure.

The present disclosure will now be described in detail with reference to the accompany drawings.

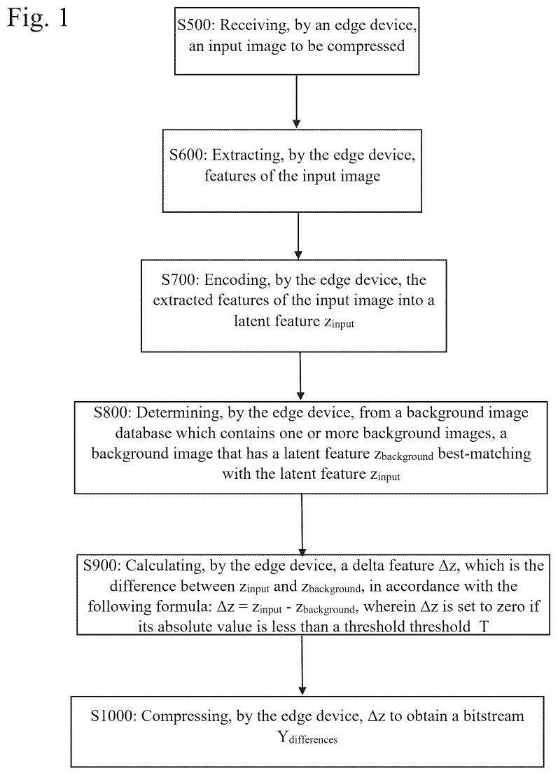

FIG. 1 is a schematic diagram illustrating an image processing method according to a first embodiment of the present disclosure.

As shown in FIG. 1, the image processing method of this embodiment may include the following steps:
receiving (S500), by an edge device, an input image to be compressed;
extracting (S600), by the edge device, features of the input image;
encoding (S700), by the edge device, the extracted features of the input image into a latent feature zᵢₙₚᵤₜ;
determining (S800), by the edge device, from a background image database which contains one or more background images, a background image that has a latent feature z_{background} best-matching with the latent feature zᵢₙₚᵤₜ;
calculating (S900), by the edge device, a delta feature Δz, which is the difference between zᵢₙₚᵤₜ and z_{background}, in accordance with the following formula: Δz=zᵢₙₚᵤₜ−z_{background}; and
compressing (S1000), by the edge device, Δz to obtain a bitstream Y_{differences}.

In a possible implementation, in the step S500, the edge device may be a camera in a CCTV (Closed-Circuit Television) camera system, and each device may have an ID (IDentifier). The input image to be compressed may be received by being captured by the camera. But the present disclosure is not limited thereto. For example, the edge device may be another device and the input image may be received in a different manner.

In a possible implementation, in the step S600, the features of the input image may be extracted using an image information extraction module of a modified CDC (Conditional Diffusion Compression) model, and in the step S700, the extracted features of the input image may be encoded into a latent feature, zᵢₙₚᵤₜ, using the modified CDC model in which its model weight has been modified and some of layers in the CDC model have been reduced.

In a possible implementation, in the step S800, a background image that has a latent feature, z_{background}, best-matching with the latent feature, zᵢₙₚᵤₜ, may be determined from a background image database which contains one or more background images. The latent features of the current image may be compared with the latent features of all background images, and the background image with a highest similarity score may be determined. L2 distance may be used to find a z_{background} best-matching with zᵢₙₚᵤₜ. A conventional method may be used to calculate the L2 distance, for example, Euclidean distance method, in accordance with which a z_{background} whose L2 distance to zᵢₙₚᵤₜ is the shortest is determined as best-matching with zᵢₙₚᵤₜ.

In a possible implementation, in the step S900, a delta feature, Δz, which is the difference between zᵢₙₚᵤₜ and z_{background}, may be calculated in accordance with the following formula: Δz=zᵢₙₚᵤₜ−z_{background}. Here, a threshold threshold_T may be introduced to set Δz to zero if the absolute value of Δz is less than the threshold threshold_T, thereby reducing computing burden and enhancing compression efficiency. In the image processing field, zᵢₙₚᵤₜ and z_{background} are two latent matrices of the same size. For example, in the CDC model, the size of the latent matrix is 32*32*128. When calculating Δz between zᵢₙₚᵤₜ and z_{background}, respective elements in the two latent matrices are compared, for example, by subtracting one another, to obtain a difference, which is Δz, for each element. Then, an absolute value of each Δz is compared with the threshold threshold_T, where Δz is set to zero if its absolute value is less than the threshold threshold_T, otherwise Δz is maintained.

Some values of the threshold threshold_T, which are obtained from experimental results, are shown in Table 1 below.

TABLE 1

| Threshold_T | MS-SSIM | PSNR | Min BPP | Max BPP | Mean BPP | String size |
|---|---|---|---|---|---|---|
| 0.5 | 0.93 | 35.84 | 0.34 | 0.40 | 0.36 | 18 kb |
| 1.0 | 0.92 | 31.74 | 0.23 | 0.30 | 0.28 | 14 kb |
| 1.25 | 0.91 | 31.63 | 0.16 | 0.21 | 0.17 | 8 kb |
| 1.5 | 0.87 | 30.62 | 0.14 | 0.19 | 0.16 | 7 kb |
| 2.0 | 0.86 | 29.62 | 0.13 | 0.18 | 0.15 | 6 kb |
| 3.0 | 0.83 | 28.20 | 0.11 | 0.16 | 0.14 | 5 kb |

*Note:
Result when testing on (512 × 768 image), the original image size is 94 KB.

As can be seen from the table above, the threshold threshold_T may range from 0.5 to 3.0. And threshold_T=1.5 is found to be the most suitable value to achieve the balance between the compression ratio and the image quality.

In a possible implementation, in the step S1000, Δz may be compressed to obtain a bitstream Y_{differences}, using a conventional entropy model.

Below is some further information about the entropy model which can be used for reference.

Entropy model: used to model the probability distribution of latent representations, which enables efficient compression by minimizing the number of bits required to represent the data. Below is a detailed explanation of its purpose and implementation in the code.

### Purpose of the Entropy Bottleneck

1. Compression Efficiency: The entropy bottleneck estimates the likelihood of latent variables (features extracted by the neural network) and uses this probability model to encode and decode data with minimal redundancy.
2. Rate-Distortion Tradeoff: It supports the balance between the size of the compressed data (rate) and the quality of the reconstruction (distortion).
3. Learned Representation: It learns to model the latent variable distribution during training, making it adaptable to specific data characteristics.

### How it Works

1. Training Phase:
   The entropy bottleneck learns the probability distribution of latent variables.
   It uses noise injection to approximate the effect of quantization, allowing gradients to propagate.
   The loss function includes a term for the likelihood, penalizing distributions that require more bits for encoding.
2. Compression Phase:
   Latent variables are quantized and encoded using the learned distribution.
   The quantized CDFs are used to efficiently encode the symbols into a compact bitstream.
3. Decompression Phase:
   The bitstream is decoded back into quantized symbols.
   The quantized symbols are converted back to latent variables, which are passed through the decoder for reconstruction.

### Significance in Neural Compression

The entropy bottleneck is a crucial component for compressing high-dimensional data like images or videos.
It ensures that the learned latent representation is both compact and decodable, optimizing the compression system for practical deployment.

In a possible implementation, before the step S500 for receiving the input image, the method may further comprise the following steps:
constructing (S100) the background image database;
extracting (S200) features of each of the background images in the database;
encoding (S300) the extracted features of each of the background images into a latent feature z_{background}; and
assigning (S400) an identifier (IDentifier—ID) to each z_{background}.

In a possible implementation, the step S100 may be for constructing a background image database containing one or more background images, for example, for each camera in a camera system. These background images may be stored on a backend server and may be used for computing a set of background image latent features, z_{background}. These background image latent features may be then stored locally on the edge device, forming a reference set that can be used for fast comparison during the compression process.

In a possible implementation, step S200 for extracting features of each of the background images in the database may be performed using an image information extraction module of a modified CDC (Conditional Diffusion Compression) model, and step S300 for encoding the extracted features of each of the background images into a latent feature, z_{background}, may be performed using the modified CDC model in which the model weight has been modified and some of the layers in the CDC model have been reduced.

In a possible implementation, step S400 may be for assigning an identifier (IDentifier—ID) to each z_{background} for facilitating the retrieval of z_{background} during a decompression process to be described later.

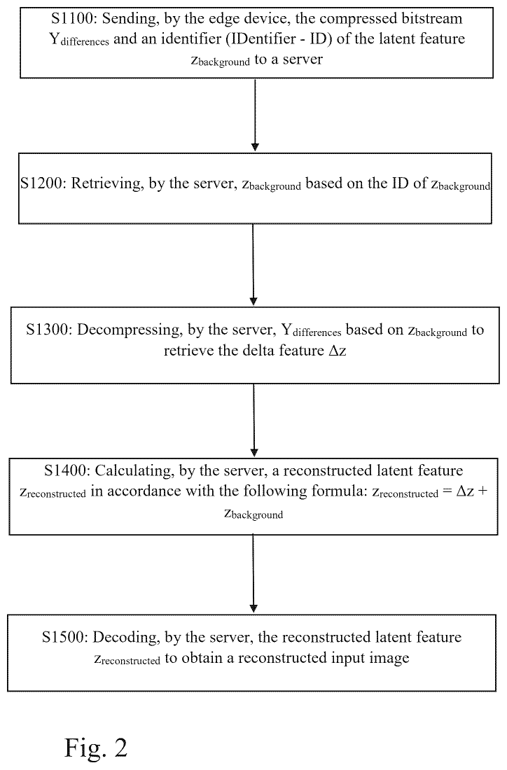

FIG. 2 is a schematic diagram illustrating an image processing method according to a second embodiment of the present disclosure. This method may be continuous from the method in the first embodiment and may be used for processing an image, for example, decompressing a compressed image obtained by the method in the first embodiment.

As shown in FIG. 2, the image processing method of this embodiment may include the following steps, in addition to the steps in the method in the first embodiment:
sending (S1100), by the edge device, the compressed bitstream Y_{differences} and an identifier (IDentifier—ID) of the latent feature z_{background} to a server;
retrieving (S1200), by the server, z_{background} based on the ID of z_{background};
decompressing (S1300), by the server, Y_{differences} based on z_{background} to retrieve the delta feature Δz;
calculating (S1400), by the server, a reconstructed latent feature z_{reconstructed} in accordance with the following formula: z_{reconstructed}=Δz+z_{background}; and
decoding (S1500), by the server, the reconstructed latent feature z_{reconstructed} to obtain a reconstructed input image.

In a possible implementation, the step S1100 may be for sending the compressed bitstream Y_{differences} and an identifier (IDentifier—ID) of the latent feature z_{background} to a server. Instead of transmitting the entire zᵢₙₚᵤₜ, only the compressed bitstream Y_{differences} and the background image latent feature ID of the best-matching background image latent features are transmitted. This significantly reduces the amount of data sent over the network.

In a possible implementation, the step S1200 may be for retrieving z_{background} based on the received ID of z_{background} at the server. Upon receiving Y_{differences} (i.e., the compressed bitstream or the compressed differences) and the background image latent feature ID, the server retrieves the corresponding z_{background} from the background image database.

In a possible implementation, the step S1300 may be for decompressing Y_{differences} based on z_{background} to retrieve the delta feature Δz. Particularly, Y_{differences} is decompressed using an entropy model to retrieve Δz, which is then combined with the background image latent features to reconstruct the input image features.

In a possible implementation, the step S1400 may be for calculating a reconstructed latent feature, z_{reconstructed}, in accordance with the following formula: z_{reconstructed}=Δz+z_{background}. That is, once the server has Δz and z_{background}, the next step is to reconstruct the input latent feature as indicated. This reconstruction ensures that the server can accurately reconstruct the input image by combining the background information with the significant foreground changes. The reconstructed image feature is then sent to CDC decode module to reconstruct the input image.

In a possible implementation, the step S1500 may be for decoding the reconstructed latent feature z_{reconstructed} to obtain a reconstructed input image. That is, the server decodes z_{reconstructed} using a neural decoder, converting the latent features back into a full-resolution image. This process completes the image reconstruction, allowing the system to display or store the image as needed. Here, a modified CDC model is used for reconstructing the input image using z_{reconstructed} instead of zᵢₙₚᵤₜ as in the related art.

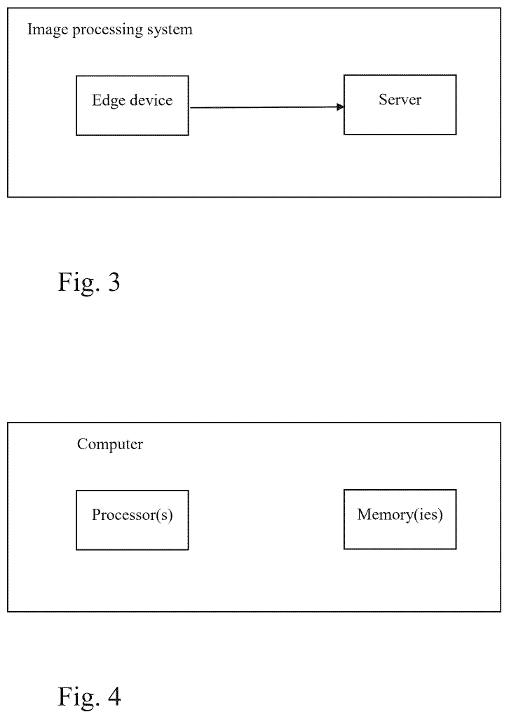

FIG. 3 is a schematic diagram illustrating an image processing system according to a third embodiment of the present disclosure. As shown in FIG. 3, the system may include an edge device, which may be a camera in a camera system, and the edge device may be used for receiving (or capturing) and compressing an image.

In a possible implementation, the edge device may be configured to perform the following steps:
receiving (S500) an input image to be compressed;
extracting (S600) features of the input image;
encoding (S700) the extracted features of the input image into a latent feature zᵢₙₚᵤₜ;
determining (S800), from a background image database which contains one or more background images, a background image that has a latent feature z_{background} best-matching with the latent feature zᵢₙₚᵤₜ;
calculating (S900) a delta feature Δz, which is the difference between the zᵢₙₚᵤₜ and z_{background}, in accordance with the following formula: Δz=zᵢₙₚᵤₜ−z_{background}; and
compressing (S1000) Δz to obtain a bitstream Y_{differences}.

In a possible implementation, the edge device may further be configured to perform a step for sending (S1100) the compressed bitstream Y_{differences} and an identifier (IDentifier—ID) of the latent feature z_{background} to a server.

In a possible implementation, as still shown in FIG. 3, the system may further include a server, and the server may be used for processing an image, for example, decompressing an image compressed by the edge device.

In a possible implementation, the server may be configured to perform the following steps:
retrieving (S1200) z_{background} based on the ID of z_{background};
decompressing (S1300) Y_{differences} based on z_{background} to retrieve the delta feature Δz;
calculating (S1400) a reconstructed latent feature z_{reconstructed} in accordance with the following formula: z_{reconstructed}=Δz+z_{background}; and
decoding (S1500) the reconstructed latent feature z_{reconstructed} to obtain a reconstructed input image.

The image processing system in the third embodiment has the same principles and concepts as those of the image processing methods in the first embodiment and the second embodiment. Therefore, for detailed implementations of each of the steps performed in the system as well as corresponding functions of the edge device and the server, reference may be made to the descriptions of the corresponding steps in the methods, and the repeated/redundant descriptions thereof will be omitted for the sake of brevity.

In a fourth embodiment, the present disclosure further provides a computer program for performing the method in the first embodiment and/or the method in the second embodiment.

In a fifth embodiment, the present disclosure further provides a computer-readable storage medium storing a computer program for performing the method in the first embodiment and/or the method in the second embodiment.

FIG. 4 is a block diagram illustrating an exemplary computer architecture for implementing aspects of the present disclosure, according to some embodiments of the present disclosure.

As shown in FIG. 4, the exemplary computer may include one or more processors, one or more memories and/or any other units. The one or more processors may be, but not limited to, a general-purpose processor, an application-specific integrated circuit (ASIC), or a field-programmable gate array (FPGA). The one or more memories may be, but not limited to, a non-volatile memory such as a hard disk drive (HDD), or a volatile memory such as a random-access memory (RAM). The one or more memories are configured to store instructions or programs and data. The one or more memories are coupled to the one or more processors. In some embodiments of the present disclosure, a computer program comprises instructions which, upon being executed by the computer, cause the one or more processors to perform the method in any of or any combination of possible implementations in the foregoing method embodiments. In other embodiments of the present disclosure, a computer-readable storage medium stores a computer program, the computer program comprises instructions which, upon being executed by the computer, cause the one or more processors to perform the method in any of or any combination of possible implementations in the foregoing method embodiments.

### Experiments and Explanations

In this section, the present disclosure presents the performance evaluation of the provided AI-based image compression model by analyzing several metrics across different threshold values used for identifying significant changes in the latent difference Δz. To assess the performance of the provided AI-based image compression model, two primary evaluation metrics: Multi-Scale Structural Similarity Index (MS-SSIM) and Peak Signal-to-Noise Ratio (PSNR), are employed, which measure the quality of the reconstructed images. Additionally, the compression efficiency is evaluated using Bits Per Pixel (BPP) and string size.
MS-SSIM quantifies the perceptual similarity between the original and compressed images, with values closer to 1 indicating better visual quality.
PSNR measures the fidelity of the reconstructed image in decibels (dB), with higher values indicating lower distortion.
BPP reflects the number of bits required to encode each pixel after compression, indicating the compactness of the compressed representation.
String size measures the total size of the transmitted compressed data, representing the overall efficiency of the compression method.

These metrics provide a comprehensive view of the trade-offs between image quality and compression efficiency. Table 1 mentioned above summarizes the results, showing how the threshold affects image quality and compression efficiency.

### Threshold Impact on Image Quality

At the lowest threshold (0.5), the MS-SSIM is the highest at 0.93, and the PSNR is 35.84 dB, indicating excellent preservation of image details and visual similarity to the original input. As the threshold increases, both MS-SSIM and PSNR gradually decrease. For example, with a threshold of 3.0, the MS-SSIM drops to 0.83, and PSNR reaches 28.20 dB. This reduction in quality corresponds to fewer details being retained in the compressed latent variable, as more changes are filtered out. Lowering the threshold increases the accuracy and fidelity of the reconstructed image but at the cost of higher data transmission sizes.

### Compression Efficiency

The compression efficiency is evaluated in terms of Bits Per Pixel (BPP), which indicates the amount of data needed to represent a pixel after compression, and string size, which represents the total size of the transmitted data in kilobytes.

At the lowest threshold (0.5), the mean BPP is 0.36, with a string size of 18 KB, reflecting that more information is being transmitted to maintain high image quality. The range of BPP values shows a minimum of 0.34 and a maximum of 0.40, suggesting a relatively high bandwidth requirement at this setting. When the threshold increases, the mean BPP decreases significantly. For example, at a threshold of 1.25, the mean BPP is 0.17, and the string size is reduced to 8 KB, indicating more efficient compression. At the highest threshold (3.0), the mean BPP reaches 0.14, with a string size of only 5 KB. This configuration provides the best compression but at the cost of a noticeable decrease in visual quality.

### Trade-Off Between Compression and Quality

The results illustrate the trade-off between compression efficiency and image quality. Lower thresholds provide better image quality, but the cost is higher for data sizes and BPP, meaning more bandwidth is required for transmission. On the other hand, increasing the threshold reduces the transmitted data and improves compression efficiency but sacrifices some image fidelity.

### One Example of an Optimal Settings

At a threshold of 1.0, the MS-SSIM remains relatively high at 0.92, and the PSNR is 31.74 dB, while the mean BPP drops to 0.28 and the string size to 14 KB. For more aggressive compression, a threshold of 1.25 provides even better efficiency (8 KB string size and 0.17 BPP) with a minimal drop in image quality (MS-SSIM: 0.91, PSNR: 31.63 dB). Based on the experimental results, a threshold value around 1.5 is found to strike a good balance between image quality and compression efficiency.

### Advantageous Effects of the Present Disclosure

Bandwidth Efficiency: By transmitting only compressed differences and background image latent features IDs, the amount of data transmitted from the edge device to the server is drastically reduced. This advantage is further enhanced in environments where the surveillance area only occupies a small portion of the entire frame area, for example, when monitoring restricted areas, private areas, or for cameras installed on highways.

Optimized for Real-Time: The computationally lightweight approach is compatible with devices which support AI computing and allows for efficient compression on embedded devices which support AI computing, enabling real-time video transmission.

High-Quality Reconstruction: The use of latent features and entropy compression ensures that the reconstructed images maintain high visual fidelity, even after compression and transmission.

The results demonstrate that the provided method provides flexible control over the balance between compression and image quality, making it suitable for varying bandwidth and quality requirements in real-time video transmission applications.

This disclosure provides an AI-based image compression model designed to reduce the transmission bandwidth between edge devices and a central processing server. By leveraging a latent background model and an entropy bottleneck layer, the provided approach efficiently compresses and transmits only the differences between the input image and the stored background, significantly minimizing data transfer without compromising image quality. The provided method leverages the differences between the current image features and pre-existing background image latent features in the latent space, rather than relying on the original image features. This difference allows for further reduction of the compressed information size through sparse encoding, without incurring additional computational overhead. In addition, in many cases with CCTV cameras, the background region often occupies a large portion of the image—sometimes up to 100% if no objects are moving in the scene. In such scenarios, the provided method can reduce the compressed data by up to 100% without compromising the quality of the reconstructed image. Further, as the provided approach exploits the static background characteristic inherent to CCTV camera systems, the provided approach substantially reduces computational time by eliminating the need for constant background checks and mitigates the risk of the reconstructed image being overly dependent on the background image. If the background images become outdated, the provided approach reverts to functioning like the CDC method, ensuring a robust fail-safe mechanism. This characteristic is crucial for real-world deployment.

The experimental results demonstrate that the model achieves a favorable balance between compression efficiency and visual fidelity, with MS-SSIM and PSNR values remaining high at moderate compression thresholds. It is further shown that sparse foreground changes in typical surveillance scenarios enable efficient delta encoding, and the entropy bottleneck layer optimizes data transmission. The model is particularly effective in scenarios where localized foreground changes dominate the frame, allowing minimization of computational load on edge devices while maintaining accuracy during decompression at the server.

In summary, the provided AI-based image compression method provides a scalable and adaptable solution for real-time video transmission, offering flexible control over the trade-off between image quality and bandwidth usage, making it well-suited for applications in resource-constrained environments such as surveillance systems.

All or some of the foregoing embodiments may be implemented by software, hardware, firmware, or any combination thereof. When software is used to implement the embodiments, the embodiments may be implemented completely or partially in a form of a computer program product. The computer program product includes one or more computer instructions. When the computer program instructions are loaded and executed on a computer, all or some of the procedures or functions are generated according to the embodiments of the present disclosure. The computer may be a general-purpose computer, a computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, microwave, or the like) manner. The computer-readable storage medium may be any usable medium accessible by a computer, or a data storage device, a server or a data center, integrating one or more usable media. The usable medium may be a magnetic medium (for example, a floppy disk, a hard disk, a magnetic tape), an optical medium (for example, a DVD), a semiconductor medium (for example, a solid-state drive), or the like.

The foregoing descriptions are merely specific implementations of the present disclosure, but are not intended to limit the protection scope of the present disclosure. A person skilled in the art can make modifications/changes/substitutions to the foregoing embodiments without departing from the technical scheme of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the appended claims.

Wherefore, I/We claim:

1. An image processing method, comprising:
receiving, by an edge device, an input image to be compressed;
extracting, by the edge device, features of the input image;
encoding, by the edge device, the extracted features of the input image into a latent feature zᵢₙₚᵤₜ;
determining, by the edge device, from a background image database which contains one or more background images, a background image that has a latent feature z_{background} best-matching with the latent feature zᵢₙₚᵤₜ;
calculating, by the edge device, a delta feature Δz, which is the difference between zᵢₙₚᵤₜ and z_{background}, in accordance with the following formula: Δz=zᵢₙₚᵤₜ−z_{background}; and
compressing, by the edge device, Δz to obtain a bitstream Y_{differences}.

2. The method according to claim 1, further comprising:
sending, by the edge device, the compressed bitstream Y_{differences} and an identifier (IDentifier—ID) of the latent feature z_{background} to a server;
retrieving, by the server, z_{background} based on the ID of z_{background};
decompressing, by the server, Y_{differences} based on z_{background} to retrieve the delta feature Δz;
calculating, by the server, a reconstructed latent feature z_{reconstructed} in accordance with the following formula: z_{reconstructed}=Δz+z_{background}; and
decoding, by the server, the reconstructed latent feature z_{reconstructed} to obtain a reconstructed input image.

3. The method according to claim 1,
wherein in the calculating of the delta feature Δz, Δz is set to zero if its absolute value is less than a threshold threshold_T.

4. The method according to claim 3,
wherein the threshold threshold_T ranges from 0.5 to 3.0.

5. The method according to claim 4,
wherein the threshold threshold_T is 1.5.

6. The method according to claim 1,
wherein before the receiving of the input image to be compressed, the method further comprises:
constructing the background image database;
extracting features of each of the background images in the database;
encoding the extracted features of each of the background images into a latent feature z_{background}; and
assigning an identifier (IDentifier—ID) to each z_{background}.

7. The method according to claim 2,
wherein before the receiving of the input image to be compressed, the method further comprises:
constructing the background image database;
extracting features of each of the background images in the database;
encoding the extracted features of each of the background images into a latent feature z_{background}; and
assigning an identifier (IDentifier—ID) to each z_{background}.

8. The method according to claim 1,
wherein the extracting of features of the input image and the encoding of the extracted features of the input image into a latent feature zᵢₙₚᵤₜ are implemented by using a modified CDC (Conditional Diffusion Compression) model.

9. The method according to claim 6,
wherein the extracting of features of each of the background images in the database and the encoding of the extracted features of each of the background images into a latent feature z_{background} are implemented by using a modified CDC (Conditional Diffusion Compression) model.

10. An image processing system, comprising:
an edge device configured to perform the following steps:
receiving an input image to be compressed;
extracting features of the input image;
encoding the extracted features of the input image into a latent feature zᵢₙₚᵤₜ;
determining, from a background image database which contains one or more background images, a background image that has a latent feature z_{background} best-matching with the latent feature zᵢₙₚᵤₜ;
calculating a delta feature Δz, which is the difference between the zᵢₙₚᵤₜ and z_{background}, in accordance with the following formula: Δz=zᵢₙₚᵤₜ−z_{background}; and
compressing Δz to obtain a bitstream Y_{differences}.

11. The system according to claim 10,
wherein the edge device is further configured to perform a step for sending the compressed bitstream Y_{differences} and an identifier (IDentifier—ID) of the latent feature z_{background} to a server; and
wherein the system further comprises a server configured to perform the following steps:
retrieving z_{background} based on the ID of z_{background};
decompressing Y_{differences} based on z_{background} to retrieve the delta feature Δz;
calculating a reconstructed latent feature z_{reconstructed} in accordance with the following formula: z_{reconstructed}=Δz+z_{background}; and
decoding the reconstructed latent feature z_{reconstructed} to obtain a reconstructed input image.

12. The system according to claim 10,
wherein in the calculating of the delta feature Δz, Δz is set to zero if its absolute value is less than a threshold threshold_T.

13. The system according to claim 12,
wherein the threshold threshold_T ranges from 0.5 to 3.0.

14. The system according to claim 13,
wherein the threshold threshold_T is 1.5.

15. The system according to claim 10, wherein before the receiving of an input image to be compressed, the edge device is further configured to perform the following steps:
constructing the background image database;
extracting features of each of the background images in the database;
encoding the extracted features of each of the background images into a latent feature z_{background}; and
assigning an identifier (IDentifier—ID) to each z_{background}.

16. The system according to claim 11, wherein before the receiving of an input image to be compressed, the edge device is further configured to perform the following steps:
constructing the background image database;
extracting features of each of the background images in the database;
encoding the extracted features of each of the background images into a latent feature z_{background}; and
assigning an identifier (IDentifier—ID) to each z_{background}.

17. The system according to claim 10,
wherein the extracting of features of the input image and the encoding of the extracted features of the input image into a latent feature zᵢₙₚᵤₜ are implemented by using a modified CDC (Conditional Diffusion Compression) model.

18. The system according to claim 15,
wherein the extracting of features of each of the background images in the database and the encoding of the extracted features of each of the background images into a latent feature z_{background} are implemented by using a modified CDC (Conditional Diffusion Compression) model.

19. A computer program which, when run on a computer having one or more processors, causes the one or more processors to perform the method according to claim 1.
